(19) United States
(12) Patent Application Publication
(10) Pub. No.: US 2007/0120012 A1
(43) Pub. Date: May 31, 2007

(54) Safe escape lock

(76) Inventor: John D. Ricker, Dover, NH (US)

Correspondence Address: SUNG I. OH, PROFESSIONAL LAW CORPORATION, 710 QUAIL VALLEY LANE, WEST COVINA, CA, 91791, US

(21) Appl. No.: 11/287,988

(22) Filed: Nov. 28, 2005

(51) Int. Cl. B64F 1/12

(52) U.S. Cl. 244/116

(57) ABSTRACT

A locking mechanism for use on watertight doors includes a mounting plate having a threaded shaft on one side and an eye element on the other side. A chain associated with the watertight door is securely attached to the eye element and is adapted to be padlocked to a lock on the watertight door to lock the door against unauthorized entry into the compartment associated with the door. A threaded nut is threadably attached to the threaded shaft. The threaded shaft extends through a bore defined through the bulkhead associated with the door into the interior of the compartment associated with the door. In the event of an emergency, the threaded nut is removed from the threaded shaft, and the locking mechanism can be removed from the bulkhead associated with the door thereby freeing the door from the bulkhead and permitting the door to be opened from inside the compartment even if the chain remains locked to the door.

### TECHNICAL FIELD OF THE INVENTION

The present invention relates generally to watertight and airtight doors. More particularly, the present invention relates to locking mechanisms for such doors.

### BACKGROUND OF THE INVENTION

A compartment, such as a sea vessel enclosure, has its opening closed in a watertight manner by a door panel hingedly mounted on the enclosure wall adjacent to the opening to form an opening closure door pivotally displaced to a closure position. Watertight doors are well known in the art. Such doors commonly are used to prevent water infiltration from one compartment of a ship to another or from one area of a building to another. Such doors also can be used to prevent infiltration of air or other gas or vapor from one volume to another. A watertight door assembly typically comprises a door; a door frame; a hinge mechanism for pivoting the door about the door frame; a resilient, compressible seal for affecting a watertight seal between the door and the door frame; and a sealing mechanism.

Sealing mechanisms used in shipboard marine applications must withstand extremely corrosive environments while maintaining watertight mechanical seals. In applications such as weatherproof deck doors, windows, hatches, and scuttles, watertight door sealing mechanisms (also known as dog latches) must provide a strong mechanical seal, must be operational through a wide range of temperature extremes, and must prevent the passage of water and air in heating ventilation and cooling systems.

Doors and hatches used in ships and analogous vessels often utilize quick-acting sealing mechanisms that allow the door or hatch to be sealed and unsealed by rotating a single handle. In many cases, the handle actuates a series of rack and pinion gears, ratchet gears, or levers, which in turn simultaneously actuate a series of dogs located around the periphery of the door. The dogs engage cam surfaces on the door frame or coaming, and pull the door against the frame to form a watertight seal between the door and the frame when the door is closed and sealed. Such sealing mechanisms are advantageous because they allow the door or hatch to be secured and sealed very rapidly.

In addition to being easily secured and sealed, a sealing mechanism for a watertight door must operate quickly to permit rapid opening and closing during a fire or other emergency situation. The just-described sealing mechanism is not easily and rapidly openable. This is especially true if the door is to be opened from the inside of the compartment. If a door cannot be quickly opened from the inside of a compartment, there may be a danger that personnel may be trapped in a compartment.

Coast Guard regulations require watertight doors to be locked to prevent unauthorized access to the compartment associated with the door. However, in the event of an emergency, personnel in the compartment should be able to exit the compartment in a rapid and orderly manner. Therefore, any lock used on such doors should be capable of being removed in a rapid and orderly manner under emergency conditions.

### SUMMARY OF THE INVENTION

The above-discussed disadvantages of the prior art are overcome by a locking mechanism for a watertight door that has a threaded shaft on one side of a mounting plate and an eye element on the other side of the mounting plate. A locking chain is securely attached to the eye element to lock the door in position by means of a hasp mechanism on the door. The mounting plate is fixed to a bulkhead associated with the door and the threaded shaft extends through a bore defined through the bulkhead associated with the door into the interior of the compartment being closed by the door. A threadable nut, such as a wing nut, is threadably mounted on the threaded shaft to secure the mounting plate to the bulkhead associated with the door. In the event of an emergency, the threaded nut can be removed from the threaded shaft and the mounting plate will then be freed of the bulkhead associated with the door and can be removed from the door bulkhead. The door will then be freed from the bulkhead and openable from within the compartment.

Using the watertight door locking mechanism embodying the present invention will permit personnel who may otherwise be locked inside a compartment to free themselves from the compartment by removing the door locking mechanism from the bulkhead associated with the door to free the door even though the personnel are located inside the compartment and the lock on the door remains in place on the door. Freeing a watertight door in an emergency situation from inside a compartment is thus quick and easy.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a watertight door locking mechanism embodying the present invention.

FIG. 2 is a side elevational view taken along line 2-2 of the watertight door locking mechanism shown in FIG. 1.

FIG. 3 is a schematic showing the lock mechanism mounted in place on a watertight door and on a bulkhead associated with the door.

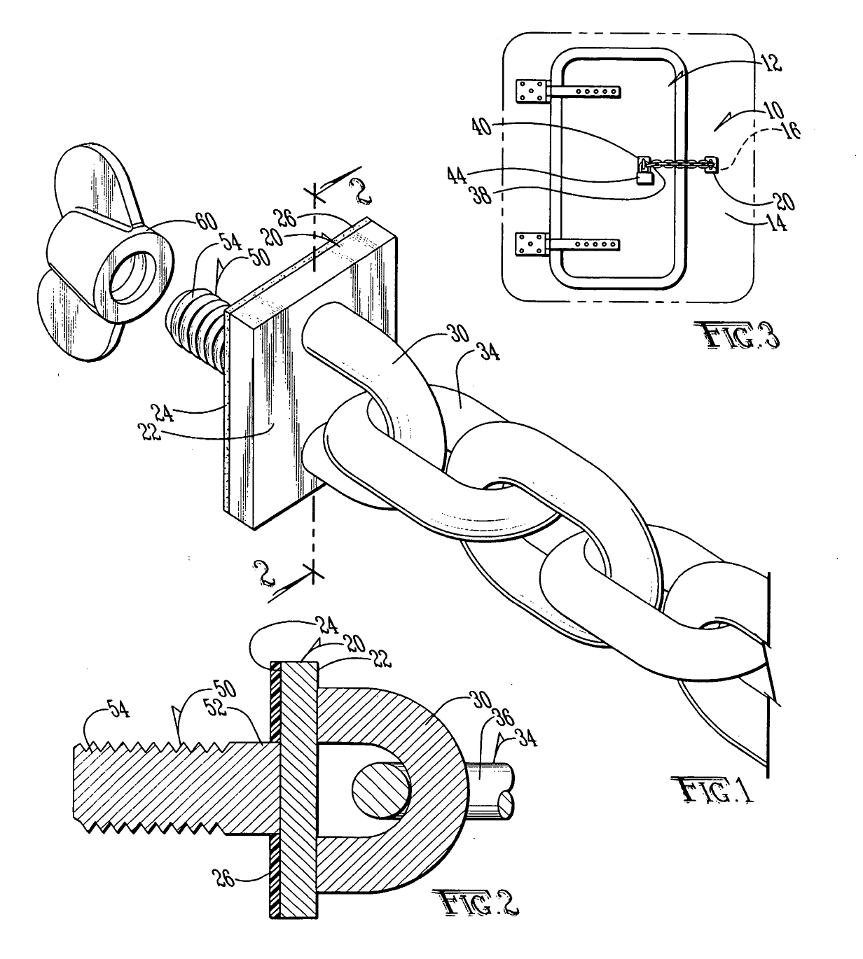

### DETAILED DESCRIPTION OF THE INVENTION

Referring to the figures, it can be understood that the present invention is embodied in a watertight door locking mechanism 10 which permits personnel located inside a compartment of a ship to easily and quickly open a door that may be locked on the outside of the door.

Mechanism 10 comprises a watertight door 12 for use on a compartment of a vessel. Watertight door 12 has a bulkhead 14 associated with the door. Bulkhead 14 has a bore 16 defined therethrough with the bore being in communication with an interior of the compartment.

A mounting plate 20 has a first surface 22 which is located adjacent to bulkhead 14 when the mounting plate is in place on the bulkhead and a second surface 24 which is interposed between first surface 22 and bulkhead 14 when the mounting plate is in place on bulkhead 14.

A sealing element 26 is mounted on second surface 24 of the mounting plate to be interposed between second surface 24 of the mounting plate and bulkhead 14 when the mounting plate is in place on the bulkhead. Sealing element 26 ensures that water or other fluids will not bypass door 12 in an undesirable manner.

An eye element 30 is securely mounted on first surface 22 of the mounting plate to be one piece with the mounting plate.

A locking chain 34 is securely fixed at one end 36 thereof to eye element 30. A second end 38 of chain 34 is adapted to be locked to a locking unit 40 on door 12. A padlock 44, or the like, can be used to affect the locking function between chain 34 and door 12.

When chain 34 is locked to locking unit 40 and to mounting plate 20, door 12 is locked against unauthorized entry into a compartment associated with door 12. The door is opened in the normal manner from outside the compartment by unlocking padlock 44 and removing chain 30 from locking unit 40 to free the door from the bulkhead.

A threaded post 50 has a first end 52 which is unitary and one-piece with second surface 24 of mounting plate 20 and a second end 54 which is spaced apart from first end 52. Threaded post 50 is accommodated in bore 16 defined through bulkhead 14 associated with the door when mounting plate 20 is in place on the bulkhead. The one piece construction of plate 20 and post 50 ensures that the plate and post will be strong and not easily defeated.

A threaded nut 60 is threadably mounted on threaded post 50 and is located in the interior volume of the compartment when threadably engaged with the threaded post when mounting plate 20 is in place on the bulkhead associated with door 12 to hold the mounting plate in place on bulkhead 14. Mounting plate 20 will be freed of bulkhead 14 when threaded nut 60 is removed from threaded post 50 whereby mounting plate 20 can be removed from bulkhead 14 after threaded nut 60 is removed from threaded post 50.

Use of mechanism 10 can be understood from the teaching of the foregoing disclosure and thus will not be presented in detail. A door is locked closed by attaching chain 34 to lock 40 on the door and placing an appropriate lock on lock 40. The other end of chain 34 is securely attached to eye element 30 which is securely fixed to bulkhead 14 via mounting plate 20. Mounting plate 20 is located with respect to door 12 whereby access to threaded nut 60 is not possible when chain 34 is locked to the door. The door is thus locked against unauthorized entry. However, in the event personnel inside the compartment associated with door 12 must exit that compartment via door 12, even when the door is locked on the outside by means of chain 34, such exit can be made by removing threaded nut 60 from threaded post 50 thereby freeing post 50 and mounting plate 20 associated therewith from bulkhead 14. Once mounting plate 20 is free of the bulkhead, the lock effected between the mounting plate and the door is free of the bulkhead, and the door can be opened from the inside even if lock 44 remains in place.

While various embodiments of the invention have been described, it will be apparent to those of ordinary skill in the art that many more embodiments and implementations are possible within the scope of this invention. For instance, the mounting plate can be attached to the outer surface of the door 12 and the threaded nut 60 can be coupled to the thread post 50 on the inner surface of the door 12. Accordingly, the invention is not to be restricted except in light of the attached claims and their equivalents.

What is claimed is:

1. A watertight door locking mechanism comprising:
A) a watertight door for use on a compartment of a vessel, the watertight door having a bulkhead associated with the door, the bulkhead associated with the door having a bore defined therethrough with the bore being in communication with an interior of the compartment;
B) a mounting plate having
(1) a first surface which is located adjacent to the bulkhead associated with the door when the mounting plate is in place on the bulkhead associated with the door,
(2) a second surface which is interposed between the first surface and the bulkhead associated with the door when the mounting plate is in place on the bulkhead associated with the door,
(3) a sealing element mounted on the second surface of the mounting plate to be interposed between the second surface of the mounting plate and the bulkhead associated with the door when the mounting plate is in place on the bulkhead associated with the door, and
(4) an eye element securely mounted on the first surface of the mounting plate;
B) a locking chain securely fixed to the eye element;
C) a threaded post, the threaded post having a first end which is unitary and one-piece with the second surface of the mounting plate and a second end which is spaced apart from the first end of the threaded post, the threaded post being accommodated in the bore defined through the bulkhead associated with the door when the mounting plate is in place on the bulkhead associated with the door; and
D) a threaded nut which is threadably mounted on the threaded post and which is located in the interior volume of the compartment when threadably engaged with the threaded post when the mounting plate is in place on the bulkhead associated with the door to hold the mounting plate in place on the bulkhead associated with the door, the mounting plate being freed of the bulkhead associated with the door when the threaded nut is removed from the threaded post whereby the mounting plate can be removed from the bulkhead associated with the door after the threaded nut is removed from the threaded post.

2. In a watertight door of the type used on ships to close compartments, the improvement comprising: a watertight door lock mechanism that is releasably mounted on a bulkhead associated with the door associated with the door, the watertight door lock mechanism including a bore defined through the bulkhead associated with the door, a mounting plate having a threaded post which extends through the bore when the mounting plate is in place on the bulkhead associated with the door, and a threaded nut that mates with the threaded post to mount the mounting plate on the bulkhead associated with the door, the mounting plate being freed of the bulkhead associated with the door when the threaded nut is removed from the threaded post whereby the mounting plate can be removed from the bulkhead associated with the door after the threaded nut is removed from the threaded post.

3. A door locking mechanism capable of being unlocked from an interior compartment of a room to allow a door that is locked from the outside of the compartment to be opened from the interior of the compartment, the door locking mechanism comprising:
a mounting plate having a threaded post adapted to pass through a bore within the compartment from the outside to the interior of the compartment, the mounting plate coupled to one end of a chain and the opposing end of the chain is adapted to attach to the outer compartment to substantially lock or open the door of the compartment; and
a threaded nut adapted to releasably couple to the threaded post within the interior of the compartment so that the door can be opened at any time by releasing the threaded nut from the threaded post.

4. The door locking mechanism according to claim 3, where the threaded post of the mounting plate is adapted pass through the bore formed within a bulkhead of the compartment.

5. The door locking mechanism according to claim 3, where the threaded post of the mounting plate is adapted pass through the bore formed within a door of the compartment.

6. The door locking mechanism according to claim 3, including a sealing element between the mounting plate and the compartment.

7. The door locking mechanism according to claim 3, the mounting plate having an eye element adapted to couple to the chain.
